(19) United States
(12) Patent Application Publication
(10) Pub. No.: US 2013/0142312 A1
(43) Pub. Date: Jun. 6, 2013

(54) X-RAY WAVEGUIDE AND X-RAY WAVEGUIDE SYSTEM

(71) Applicant: Canon Kabushiki Kaisha, Tokyo (JP)

(72) Inventors: Kohei Okamoto, Yokohama-shi (JP); Atsushi Komoto, Moriya-shi (JP); Wataru Kubo, Inagi-shi (JP); Hirokatsu Miyata, Hadano-shi (JP); Takashi Noma, Hadano-shi (JP)

(73) Assignee: CANON KABUSHIKI KAISHA, Tokyo (JP)

(21) Appl. No.: 13/691,002

(22) Filed: Nov. 30, 2012

(30) Foreign Application Priority Data
Dec. 2, 2011 (JP) 2011-265068

(51) Int. Cl. G21K 1/00

(52) U.S. Cl. CPC G21K 1/00
USPC 378/145

(57) ABSTRACT

An X-ray waveguide includes a core configured to guide X-ray therethrough and a cladding. In a section perpendicular to an X-ray guiding direction, the core has threefold or more rotational symmetry and has a periodic structure made of plural substances each having a different value of a real part of refractive-index, and a critical angle for total reflection of an X-ray at an interface between the core and the cladding is larger than a Bragg angle of the X-ray for the periodic structure of the core. A waveguide mode having a two-dimensionally spatial coherence over a wide cross-section of the core and exhibiting a small propagation loss is realized.

### BACKGROUND OF THE INVENTION

1. Field of the Invention

The present invention relates to an X-ray waveguide and an X-ray waveguide system including an X-ray source and an X-ray waveguide. The X-ray waveguide according to an embodiment of the present invention can be used, for example, in an X-ray optical system for, e.g., X-ray analysis technology, X-ray imaging technology, and X-ray exposure technology, and in X-ray optical components employed in the X-ray optical system.

2. Description of the Related Art

An electromagnetic wave having a short wavelength of several tens nm or less, e.g., an X-ray, exhibits a very small difference in refractive index between different substances. As a result, a critical angle for the total reflection between the different substances is very small for the electromagnetic wave having, e.g., such a short wavelength. It is more difficult to control the electromagnetic wave having the short wavelength than to control an electromagnetic wave in, e.g., a visible band. Hitherto, a large-sized spatial optical system has mainly been used to control the electromagnetic wave having the short wavelength, e.g., the X-ray. One of main components constituting the large-sized spatial optical system is a multilayer mirror in which materials having different refractive indices are alternately laminated. The multilayer mirror has various functions, such as beam shaping, conversion of a spot size, and wavelength selection.

Other than the above-mentioned spatial optical system having mainly been used so far, recently there has been studied an X-ray waveguide, which takes advantage of total internal reflection, to confine an X-ray inside a core having a very small cross-section in two-dimensional directions. See, for example, “Applied Physics A”, Volume 91, Number 1, p. 7 (2008)). In addition, an X-ray propagation element called a polycapillary has been investigated. In the polycapillary structure, a plurality of capillaries in a form confining an X-ray inside a tube-shaped waveguide with total reflection are bundled together; see Japanese Patent No. 4133923.

In the X-ray waveguide described in the above-reference paper, however, since the X-ray is confined in the core of the waveguide just by utilizing total reflection, a cross-sectional area of the core has to be very small in order to form a single waveguide mode which is spatially coherent over a cross-section of the waveguide, or a waveguide mode close to the single mode. Conversely, if the cross-sectional area of the core of the X-ray waveguide is increased, many high-order waveguide modes appear and mix in the waveguide. Thus, it is very difficult to form a single waveguide mode. With the X-ray propagation element described in Japanese Patent No. 4133923, a core of each of the individual capillaries forming the polycapillary has a very large diameter of several tens of micrometers. In the core having such a large cross-sectional area, the X-ray cannot form a single waveguide mode for the reasons discussed above. Moreover, in the above-described related arts, because the waveguide mode is formed by confining the X-ray just by utilizing total reflection at the interface between the cladding and the core, lack of accuracy in the fabrication of that interface greatly affects an X-ray propagation loss.

### SUMMARY OF THE INVENTION

An embodiment of the present invention provides an X-ray waveguide capable of producing a waveguide mode which is spatially coherent over a large cross-sectional area of a core and a propagation loss is small.

According to an embodiment of the present invention, an X-ray waveguide includes a core configured to guide X-ray therethrough and a cladding, wherein, in a section perpendicular to the guiding direction of an X-ray, the core has threefold or more rotational symmetry and has a periodic structure made of plural substances each having a different value of a real part of refractive index, and a critical angle for the total reflection of the X-ray at an interface between the core and the cladding is larger than a Bragg angle of the X-ray for the periodic structure of the core.

Further features of the present invention will become apparent from the following description of exemplary embodiments with reference to the attached drawings.

### BRIEF DESCRIPTION OF THE DRAWINGS

FIGS. 1A, 1B and 1C are schematic sectional views, taken along a plane perpendicular to a guiding direction, of three types of X-ray waveguides according to embodiments of the present invention.

FIGS. 2A, 2B and 2C are schematic sectional views, taken along a plane perpendicular to a guiding direction, of three examples of circular symmetric X-ray waveguides according to embodiments of the present invention.

FIG. 3 is a schematic sectional view, taken along a plane including an axis of rotational symmetry, of the X-ray waveguide according to an embodiment of the present invention.

FIG. 4 is an illustration to explain the relationship between a waveguide mode and a wavevector in the X-ray waveguide according to an embodiment of the present invention.

FIG. 5 is a graph representing, based on calculation results, the relationship between a propagation loss and an effective propagation angle of each waveguide mode in the X-ray waveguide according to an embodiment of the present invention.

FIG. 6 is a graph representing an example of electric field intensity distribution in a periodic resonant waveguide mode.

FIG. 7 is a schematic sectional view, taken along a plane perpendicular to a guiding direction, of an X-ray waveguide according to an embodiment of the present invention.

FIG. 8 is a schematic sectional view, taken along a plane including an axis of rotational symmetry, of a portion near an output end of the X-ray waveguide according to an embodiment of the present invention.

FIG. 9 is a schematic sectional view, taken along a plane perpendicular to a guiding direction, of an X-ray waveguide according to an embodiment of the present invention, the X-ray waveguide including a portion that is different from a periodic structure of a core.

FIGS. 10A and 10B each illustrates a graph representing, based on calculation results, the relationship between a propagation loss and an effective propagation angle of each waveguide mode in the X-ray waveguide according to the embodiment of the present invention.

FIG. 11 is a schematic sectional view, taken along a plane including an axis of rotational symmetry, of a portion near an output end of the X-ray waveguide according to an embodiment of the present invention.

FIG. 12 is a schematic perspective view illustrating an X-ray waveguide of EXAMPLE 1.

FIG. 13 is a graph representing, based on calculation results, the relationship between a propagation loss and an effective propagation angle of each waveguide mode in the X-ray waveguide of EXAMPLE 1.

FIG. 14 is a schematic perspective view illustrating an X-ray waveguide of EXAMPLE 4.

### DESCRIPTION OF THE EMBODIMENTS

In the present disclosure, the term “X-ray” implies an electromagnetic wave in a wavelength band where a real part of the refractive index of a substance has a value of 1 or less. More specifically, in the present disclosure, the term “X-ray” implies an electromagnetic wave in a wavelength range of 1 picometer (pm) or longer (including Extreme Ultra Violet (EUV) light) to 100 nanometers (nm) or shorter.

A frequency of the electromagnetic wave having such a short wavelength is very high, and an outermost electron of a substance is usually not responsive to that electromagnetic wave. It is hence known that a real part of the refractive index of a substance has a value smaller than 1 for the X-ray unlike for electromagnetic waves (visible light and infrared light) in a frequency band where wavelengths are not shorter than that of ultraviolet light. The refractive index of a substance susceptible to X-ray is expressed by a complex number. In this specification, a real part of the complex refractive index is called a “refractive-index real part” or a “real part of the refractive index”, and an imaginary part of the complex number is called a “refractive-index imaginary part” or an “imaginary part of the refractive index”.

Given that the refractive-index real part is n′, a deviation of n′ from 1 is δ, and the refractive-index imaginary part related to absorption is β′, a refractive index n of a substance for the above-mentioned X-ray is generally expressed by the following formula (1):

n=1−δ−iβ′=n′−iβ′ (1)

Because δ is proportional to an electron density ρₑ of a substance, the refractive-index real part has a smaller value as the substance has a larger electron density. The refractive-index real part n′ is expressed by (1−δ). Moreover, the electron density ρₑ is proportional to an atomic density ρₐ, and an atomic number Z. The refractive-index real part is maximized for the X-ray when the X-ray propagates in vacuum. In typical environments on the earth, the refractive-index real part is maximized in air in comparison with those of almost all substances other than gases. The term “substance” used in this specification involves air and vacuum. In the present disclosure, the expression “plural substances each having a different value of a real part of refractive-index” implies two or more substances having different electron densities in many cases. Here, (one of) the plural substances may be air or vacuum.

An X-ray waveguide according to an embodiment of the present invention is configured to propagate X-ray therethrough by confining X-rays in a core by total reflection at the interface between the core and a cladding so as to form a waveguide mode. Propagation modes can be found corresponding to the eigenvalue solutions of the wave equation of the system. Among those propagation modes, waveguide mode is defined as the mode whose longitudinal component of the wavevector in the core is the complex or only real number and it is only the imaginary number outside the core. This means there is no real field outside the core for the waveguide modes. Here, longitudinal component is along the direction perpendicular to the core-cladding interface. In the present specification, a “waveguide mode” may be generally understood as a spatial distribution of electromagnetic energy (e.g., X-rays) in one or more dimensions which remain substantially constant as it propagates through the core of the waveguide. The interface between the core and the cladding is called the “core-cladding interface” in this specification.

The core has a periodic structure and has threefold or more rotational symmetry in a plane perpendicular to a guiding direction of X-rays. The core has the periodic structure in a direction perpendicular to the core-cladding interface. The expression “threefold or more rotational symmetry” implies that the core involves not only a core having geometrically complete symmetry, but also a core shifted from the geometrically complete symmetry to such an extent as not deteriorating X-ray waveguide characteristics. In this specification, the term “guiding direction” implies a propagating direction in which an electromagnetic wave (X-ray) propagates through the X-ray waveguide while producing a waveguide mode therein; and the guiding direction is parallel to a direction in which a propagation constant of the waveguide mode is defined. In the present disclosure, the guiding direction is matched with the axis of rotational symmetry in many cases.

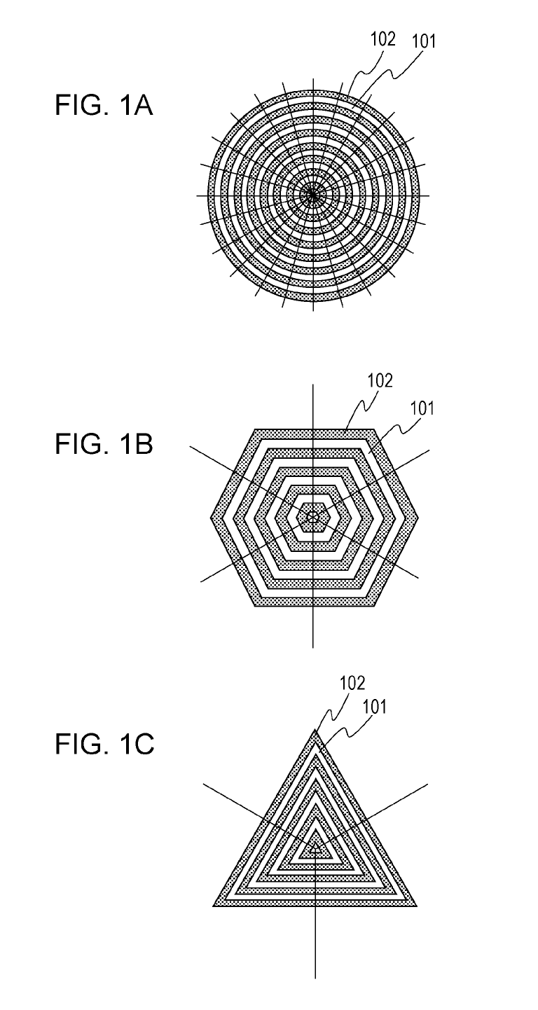

FIGS. 1A to 1C are illustrations to explain three types of X-ray waveguides according to embodiments of the present invention. More specifically, FIGS. 1A to 1C are schematic sectional views each representing, when the X-ray guiding direction is defined as the z-direction, an xy-section perpendicular to the X-ray guiding direction. Vectors indicating the directions are not denoted in FIG. 1.

A structure of FIG. 1A represents an example of a cross-section of an X-ray waveguide having circular symmetry, i.e., the highest order of rotational symmetry. The periodic structure of the core includes plural layers of substances each having a different value of the refractive-index real part. In this manner, the core constitutes a Bragg structure where electromagnetic radiation, e.g. X-ray, undergoes specular reflection in accordance with Bragg's law. As illustrated in FIG. 1A, the periodic structure is provided by concentrically alternately forming plural layers substances 101 and 102 at equal intervals, which differ in value of the refractive-index real part from each other. In a section perpendicular to a guiding direction, infinite axes of rotational symmetry passing the center of a circle perpendicularly interest the core-cladding interface. On the axis of rotational symmetry, the plural substances are periodically formed with a constant period in the direction of the axis of rotational symmetry.

In the present disclosure, the core may have a sectional shape of, e.g., a regular polygon. FIGS. 1B and 1C illustrate respectively the structure of a core having a regular hexagonal section and the structure of a core having a regular triangular section. Those structures have respectively six and three axes of rotational symmetry with each axis starting from a rotational center of the core. On each of those axes of rotational symmetry, the plural substances are formed at a constant period in the direction of the axis of rotational symmetry. In the present disclosure, cores having other sectional shapes than ones illustrated in FIGS. 1A to 1C can also be practiced as embodiments of the present invention insofar as those cores satisfy the requirements defined in claims.

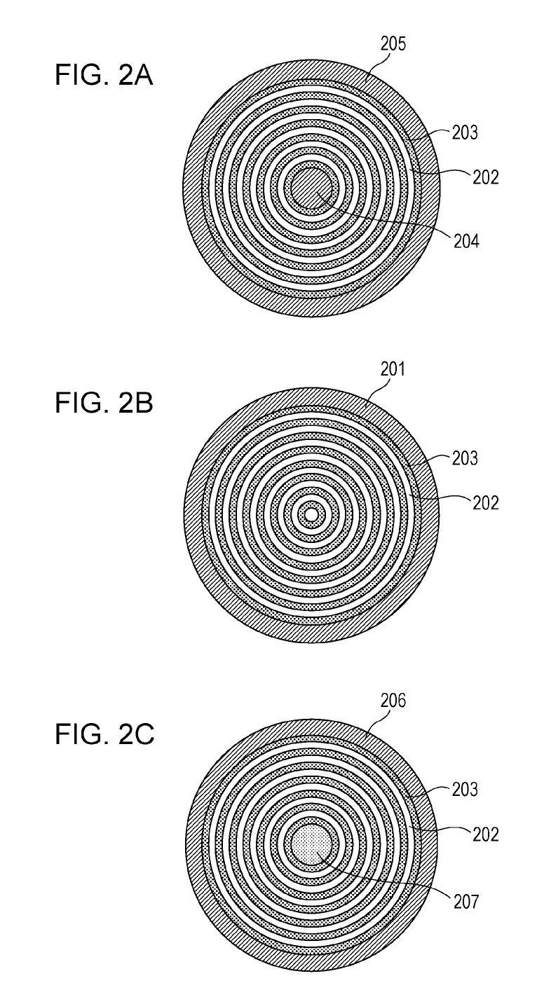

FIGS. 2A to 2C are schematic sectional views, taken along a plane perpendicular to a guiding direction, of three typical examples of circular symmetric X-ray waveguides according to embodiments of the present invention. In FIGS. 2A to 2C, regions denoted by 201, 204, 205 and 206 represent claddings. In each of those X-ray waveguides according to the embodiments of the present invention, a core has a periodic structure made of substances 202 and 203 differing in value of the refractive-index real part. An example illustrated in FIG. 2A is constituted by the cladding 204 formed near the center of the core, the core formed around the cladding 204, and the cladding 205 formed so as to surround the core. In FIG. 2A, since the cladding 204 near the center is positioned on the inner side of the core, it is called an inner cladding. In an example illustrated in FIG. 2B, the cladding 201 is formed around the core. Insofar as selective low-loss propagation of the X-ray in the periodic resonant waveguide mode is not impaired, another material that does not function as the cladding for confining the X-ray in the core may be formed in a central portion of the core. The central portion of the core may be, e.g., a hollow cavity. FIG. 2C illustrates one example of such a modification. In the example of FIG. 2C, the cladding 206 is formed around the core (substantially concentric to the core) as in the example of FIG. 2B, but another material 207 not functioning as the cladding is present in the central portion of the core.

Furthermore, the X-ray waveguide according to the embodiment of the present invention is featured in that a critical angle for the total reflection of the X-ray at the core-cladding interface is larger than a Bragg angle of the X-ray for the periodic structure of the core.

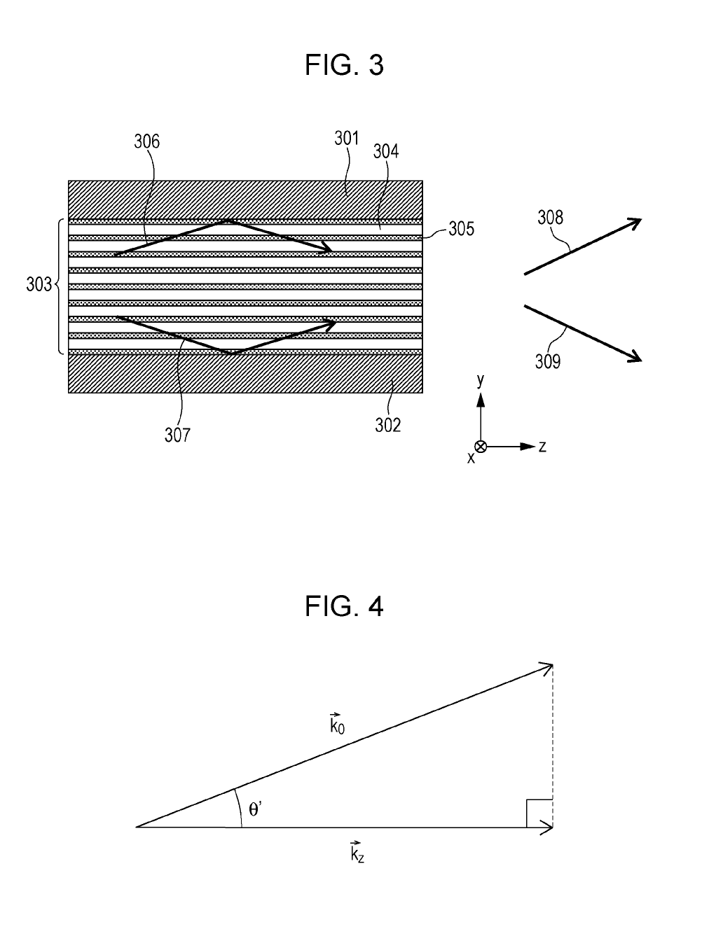

Because the core of the X-ray waveguide according to the embodiment of the present invention has the periodic structure on the axis of rotational symmetry in the section perpendicular to the guiding direction, the X-ray can propagate through the core while resonating with the periodic structure. The X-ray waveguide according to the embodiment of the present invention is described below in connection with an example of the X-ray waveguide that has the simplest structure in a section parallel to the guiding direction. As illustrated in FIG. 3, between an upper cladding 301 and a lower cladding 302, there is formed a core 303 having a periodic structure, i.e., a structure in which layers 304 and 305 each having a different refractive-index real part from each other are periodically laminated in the direction of the axis of rotational symmetry. The layer 304 exhibits a larger value of the refractive-index real part than the layer 305. An arrow 306 denotes the behavior of the X-ray totally reflected at an upper core-cladding interface, and an arrow 307 denotes the behavior of the X-ray totally reflected at a lower core-cladding interface. Thus, the X-ray impinging against the core-cladding interface at an angle not larger than the critical angle for the total reflection is confined in the core with the total reflection. In this specification, the propagation angle of the X-ray in the section parallel to the guiding direction is defined as an angle from a direction parallel to the guiding direction. It is to be noted that the term “critical angle for total reflection” used in the present invention and this specification is expressed by, instead of the so-called incidence angle (i.e., an angle from a line normal to an incidence plane), a supplementary angle of the incidence angle.

The X-ray confined in the core by the total reflection at the core-cladding interface forms waveguide modes in the core. Of those waveguide modes, the waveguide mode used in the X-ray waveguide according to the embodiment of the present invention is a waveguide mode that resonates with periodicity of the periodic structure of the core. Such a waveguide mode is called a “periodic resonant waveguide mode”. The X-ray waveguide according to the embodiment of the present invention is constructed to satisfy, as a condition for producing the periodic resonant waveguide mode, that the critical angle for the total reflection of the X-ray at the core-cladding interface is larger than the Bragg angle of the X-ray for the periodic structure of the core.

Given that a refractive-index real part of a substance on the cladding side at the interface between the core and the cladding is n_{clad} and a refractive-index real part of a substance on the core side at the interface is n_{core}, a critical angle for the total reflection θ_{C}(°) is expressed by the following formula (2) on condition of n_{clad}<<n_{core}:

$${θ}_{C} = arccos ( \frac{{n}_{clad}}{{n}_{core}} ) \qquad ( 2 )$$

Given that a period of the periodic structure of the core in the direction of the axis of rotational symmetry is d when viewed on the axis of rotational symmetry in the section perpendicular to the guiding direction, and an average refractive-index real part of a one-dimensional core periodic structure constituting the core is n_{avg}, a Bragg angle θ_{B}(°) attributable to the periodicity of the periodic structure of the core can be defined by the following formula (3). The average refractive-index real part can also be calculated from the respective refractive-index real parts of the substances constituting the core, the thickness of each substance in the direction of the axis of rotational symmetry, etc.:

$${θ}_{B} = arcsin ( \frac{1}{{n}_{avg}} \frac{λ}{2 d} ) \qquad ( 3 )$$

where λ is the wavelength of the X-ray. For simplification of explanation, the above formula (3) defines the Bragg angle on the basis of a Bragg angle that is defined with respect to, e.g., X-ray diffraction in a crystal. When element structures each having a finite size constitute a periodic structure as in the present invention, it is required, strictly speaking, to consider reflections and refractions at plural interfaces in the periodic structure. Thus, since an exact Bragg angle deviates from the Bragg angle defined by the formula (3), it is to be determined with measurement based on an experiment of X-ray diffraction or to be determined using the theory of multiple interference in a multilayer film, for example. However, the Bragg angle defined by the formula (3) does not make the purport of the present invention ineffective, and it can serve as a guidepost for the Bragg angle that is used to set structural conditions in the present invention.

Physical property parameters of the substances constituting the X-ray waveguide according to the embodiment of the present invention, structural parameters of the waveguide, and the wavelength of the X-ray are designed with satisfaction of the following formula (4). It is to be noted that because the formula (3) is just a guidepost as described above, θ_{B} is to be determined on the basis of, e.g., an actually measured value. When the design is carried out on condition of θ_{B} being much larger than angle θ_{C}, θ_{B} may be calculated using the formula (3).

θ_{B}<θ_{C} (4)

By satisfying the formula (4), the X-ray having the effective propagation angle near the Bragg angle, which is attributable to the one-dimensional periodicity of the core having the one-dimensional core periodic structure, can be confined in the core with the total reflection at the core-cladding interface. As a result, the waveguide mode resonant with the periodic structure of the core can be formed, thus enabling the X-ray to propagate on that waveguide mode. When the X-ray waveguide according to the embodiment of the present invention has a structure with even-number-fold rotational symmetry in which core-cladding interfaces opposed to each other in parallel are present, such a structure is advantageous in that the X-ray is strongly confined between the pair of the core-cladding interfaces. Even when the X-ray waveguide has a structure with odd-number-fold rotational symmetry in which core-cladding interfaces opposed to each other in parallel are not present, the X-ray can also be confined because the waveguide mode is formed over an entire core region of a waveguide section. It is supposed in this specification that an effective propagation angle β′(°) is expressed by the following formula (5) using a wavevector k_{z} (propagation constant k_{z} is the absolute value of k_{z}) in the guiding direction of the waveguide mode and a wavevector k_{D} in vacuum. Because k_{z} is constant at each layer interface due to the continuous condition of an electromagnetic wave at a substance interface, the effective propagation angle θ′(°) represents, as illustrated in FIG. 4, an angle at which a fundamental wave of the waveguide mode advances in vacuum in the plane parallel to the section parallel to the guiding direction, as an angle defined between k_{z} of the fundamental wave of the waveguide mode and the wavevector k_{D} in vacuum. Such definition is also used in the following description because it can be considered as approximately representing the propagation angle of the fundamental wave of the waveguide mode in the section parallel to the guiding direction.

$${θ}^{′} = arccos ( \frac{{k}_{z}}{{k}_{0}} ) \qquad ( 5 )$$

Because the core periodic structure constituting the core according to the embodiment of the present invention is the one-dimensional core periodic structure made of the plural substances, which differ in value of the refractive-index real part, in the section perpendicular to the guiding direction, the critical angle for the total reflection due to the difference in the refractive-index real part exists at each of the interface between unit structures and the interface between the substances adjacent to each other. Given that such a critical angle for the total reflection is θ_{c-multi}(°), the X-ray is confined inside each unit structure with the total reflection at each interface in the periodic structure of the core, thereby forming the waveguide mode, when the following formula (7) is satisfied.

θ_{C}_{_{—}}ₘᵤₗₜᵢ<θ_{B} (6)

θ_{C}_{_{—}}ₘᵤₗₜᵢ>θ_{B} (7)

If, as expressed by the formula (6), the critical angle for the total reflection at each interface in the periodic structure of the core is smaller than the Bragg angle that is attributable to the periodicity of the periodic structure of the core, the X-ray entering each interface in the periodic structure of the core at an angle not smaller than approximately the Bragg angle is partially reflected or refracted without being totally reflected. Because the one-dimensional core periodic structure can be regarded as a structure in which layers made of the substances differing in value of the refractive-index real part are periodically laminated, there are plural interfaces in the laminated direction such that the X-ray within the periodic structure of the core repeats reflection and refraction at those plural interfaces. The repetition of reflection and refraction of the X-ray within the periodic structure of the core causes multiple interference. As a result, X-rays under conditions capable of being resonant with the periodic structure, i.e., propagation modes capable of existing within the periodic structure of the core, are formed, whereby waveguide modes are formed in the core of the X-ray waveguide according to the embodiment of the present invention. Since those waveguide modes are in resonance with the periodicity of the periodic structure of the core, they are called the “periodic resonant waveguide modes” in this specification.

Those periodic resonant waveguide modes have individual effective propagation angles, and the effective propagation angle of the periodic resonant waveguide mode, which has a minimum effective propagation angle among all the periodic resonant waveguide modes, appears near the Bragg angle attributable to the one-dimensional periodic structure. That periodic resonant waveguide mode corresponds to a propagation mode of the lowest-order band when the one-dimensional core periodic structure is a one-dimensional photonic crystal being infinite in periodic number. Such a propagation mode is confined in the core with the total reflection at the core-cladding interface.

In an actual one-dimensional core periodic structure, because the periodic number is finite, its photonic band structure deviates from that of the one-dimensional core periodic structure having an infinite period number. However, as the periodic number increases, characteristics of the waveguide mode approach those of the photonic band structure having an infinite period number. Furthermore, because Bragg reflection is caused by an effect of a photonic band gap due to periodicity and the effective propagation angle of the periodic resonant waveguide mode corresponds to a propagation angle of the propagation mode at the edge of the photonic band gap, the Bragg angle becomes an angle slightly larger than the effective propagation angle of the periodic resonant waveguide mode. In a spatial distribution of electric field intensity in the periodic resonant waveguide mode, the number of antinodes of the electric field intensity is basically matched with the periodic number of the one-dimensional core periodic structure.

In the one-dimensional core periodic structure having a finite periodic number, there may exist waveguide modes having angles other than the effective propagation angle of the periodic resonant waveguide mode described above. Such a waveguide mode is not the periodic resonant waveguide mode and is a waveguide mode that exists when the entirety of the one-dimensional core periodic structure may be considered as a homogeneous medium in which the refractive-index real part is averaged. Thus, because such a waveguide mode is a waveguide mode not resonating with the periodic structure, its characteristics are basically less affected by the periodicity of the one-dimensional core periodic structure. On the other hand, in the periodic resonant waveguide mode realized with the X-ray waveguide according to the embodiment of the present invention, as the periodic number of the periodic structure of the core increases, an electric field is further localized toward the center of the one-dimensional core periodic structure and the evanescent tail in the cladding, which is seeped electromagnetic field from the core is reduced, whereby a propagation loss of the X-ray is reduced. Moreover, the periodic resonant waveguide mode used in the X-ray waveguide according to the embodiment of the present invention is spatially coherent, which means the field is spatially in phase, in the direction of the axis of rotational symmetry in the section perpendicular to the guiding direction, thus exhibiting spatial coherence. As a result, when the X-ray in the periodic resonant waveguide mode outputs from an end surface of the waveguide, it forms two diffracted beams each having a very small divergence angle in a far-field region, as denoted by 308 and 309 in FIG. 3. Those diffracted beams propagate in directions symmetrical with respect to the X-ray guiding direction. Because the plural or infinite axes of rotational symmetry have the same periodicity due to the rotational symmetry, phases in the directions of those axes of rotational symmetry match in the section perpendicular to the guiding direction, and the periodic resonant waveguide modes become spatially coherent over the cross-section of the waveguide. In other words, two-dimensional waveguide modes spatially coherent over the cross-section of the waveguide can be formed. In the present disclosure, the expression “the waveguide mode is spatially coherent” or “the field of the waveguide mode is in phase” implies not only that a relative phase of the electromagnetic field is 0 in the plane perpendicular to the guiding direction, but also that the relative phase of the electromagnetic field periodically changes between −π and +π corresponding to a spatial distribution of the refractive index in the periodic structure of the core. In the periodic resonant waveguide mode according to the present disclosure, the phase of the electric (or magnetic) field changes between −π and +π at the same period as that of the periodic structure of the core in the direction perpendicular to the guiding direction.

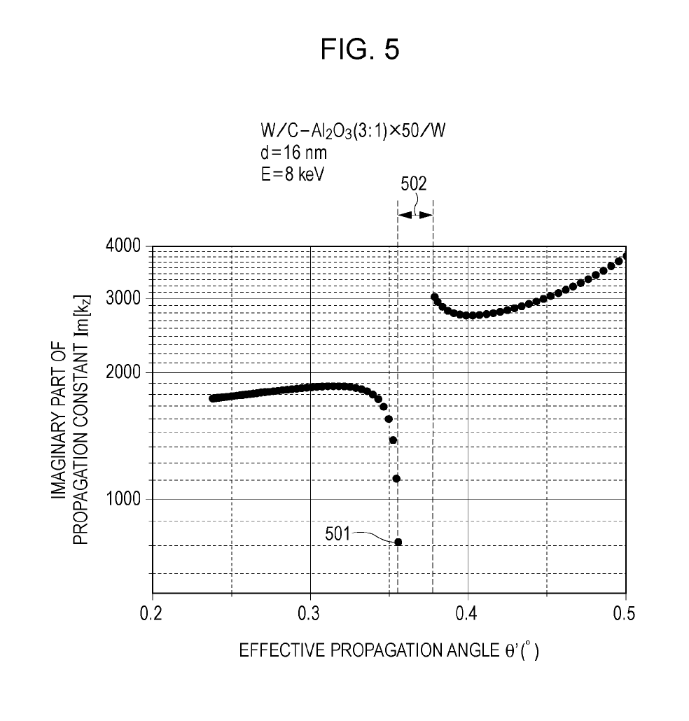

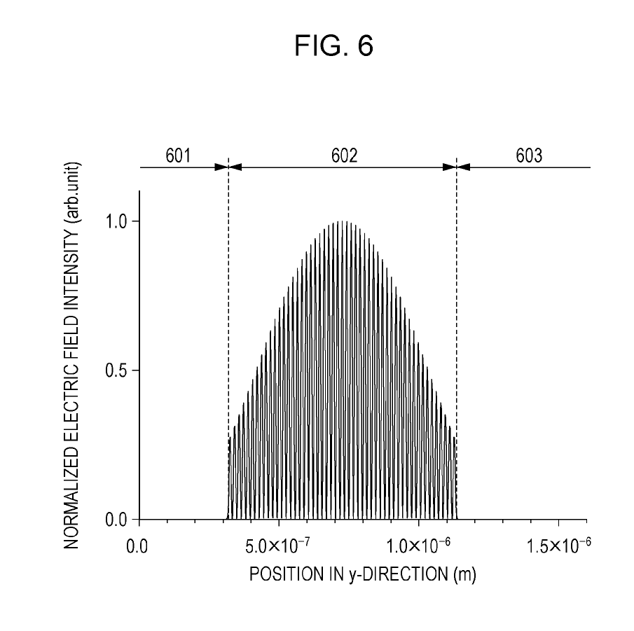

FIG. 5 is a graph representing calculation results of a propagation loss and an effective propagation angle of each waveguide mode that is formed in a y-z plane in the example of the X-ray waveguide, illustrated in FIG. 3, by an X-ray having photon energy of 8 keV. The calculation is premised on that the cladding is made of tungsten, and that the periodic structure of the core is provided as a periodic multilayer film in which carbon (C) and aluminum oxide (Al₂O₃) are alternately laminated on the axis of rotational symmetry, the periodic structure having a period of 16 nm and a periodic number of 25. An imaginary part of the propagation constant of the waveguide mode is related to a propagation loss of the waveguide mode, and the propagation loss increases as a value of the imaginary part increases. Accordingly, the vertical axis of FIG. 5 represents the imaginary part Im [k_{z}] of the propagation constant as the propagation loss. The waveguide mode having a smaller effective propagation angle is a lower-order waveguide mode. As the effective propagation angle increases, the order of the waveguide mode increases and so does the propagation loss. However, the waveguide mode is not formed in an angle range 502, in FIG. 5, which corresponds to the photonic band gap in the photonic band structure. At the edge of the angle range 502, there is a point 501 representing the waveguide mode that exhibits a distinctively small loss. The waveguide mode corresponding to the point 501 is the periodic resonant waveguide mode. FIG. 6 is a graph representing a distribution of electric field intensity in the periodic resonant waveguide mode represented by the point 501. The horizontal axis of FIG. 6 represents a position on a y-axis in the y-z plane in FIG. 3. Regions 601 and 603 in FIG. 6 correspond to the cladding portions 301 and 302 in FIG. 3, respectively, and a region 602 corresponds to the core 303 in FIG. 3. The propagation loss of the periodic resonant waveguide mode is distinctively small, as illustrated in FIG. 5, for the reasons that antinodes of the electric field intensity distribution in FIG. 6 are located in the low-loss material portions in the periodic structure of the core, and from an envelop shape of the electric field intensity distribution over a core region, the electric field is totally concentrated in the center of the core, whereby an amount of the evanescent tails in the claddings is reduced. Thus, since the periodic resonant waveguide mode has a very smaller propagation loss than the other waveguide modes, it becomes a dominant waveguide mode resulting in being spatially coherent. In the X-ray waveguide having rotational symmetry, the periodic resonant waveguide mode attributable to the above-described one-dimensional periodicity can be formed for each of plural directions of the axes of rotational symmetry, and the periodic resonant waveguide mode formed in the cross-section of the waveguide is basically given as a two-dimensional periodic resonant waveguide mode resulting from overlapping of the periodic resonant waveguide modes attributable to the one-dimensional periodicity with one another. Such a two-dimensional periodic resonant waveguide mode also has rotational symmetry similar to that of the structure of the X-ray waveguide in the cross-section thereof. For example, in the X-ray waveguide having the circular-symmetric cross-section of the above-described structure, the distribution of the electric field in the periodic resonant waveguide mode is also circularly symmetric when viewed in the cross-section of the waveguide, and the periodicity of the distribution of the electric field due to the X-ray is matched with that of the periodic structure. The two-dimensional periodic resonant waveguide mode is spatially coherent over the cross-section of the waveguide.

A typical structure of the X-ray waveguide according to the embodiment of the present invention will be described below.

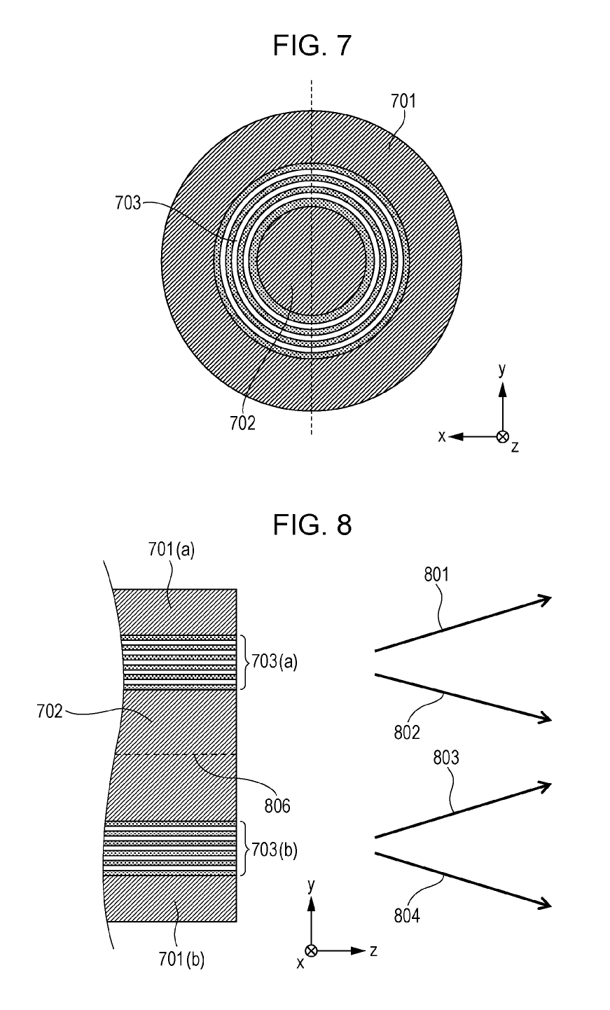

The X-ray waveguide satisfying the formula (4) is advantageously constructed such that claddings are disposed inside and outside a core in the cross-section of the waveguide, as described above with reference to FIG. 2A. With such a structure, it is possible to not only confine the X-ray in the core with the total reflection at the core-cladding interface between the core and the outer cladding surrounding the core in the cross-section of the waveguide, but also to confine the X-ray in the core with the total reflection at the core-cladding interface between the core and the inner cladding. Additionally, the X-ray waveguide is constructed such that the critical angle for the total reflection at the core-cladding interface between the core and the inner cladding also satisfies the formula (4). In such a case, the structure in the section perpendicular to the guiding direction is equivalent to that in the example of the simplest X-ray waveguide illustrated in FIG. 3, and the periodic structure of the core is sandwiched between the outer and inner claddings on the axis of rotational symmetry. Therefore, the X-ray is confined in the core with the total reflection at the two core-cladding interfaces. Furthermore, the periodic resonant waveguide mode can be formed which resonates with the periodic structure in the core region sandwiched between the two claddings, and which becomes a dominant waveguide mode. For more detailed description, FIG. 7 illustrates an example of the cross-section of the X-ray waveguide having the above-described structure, and FIG. 8 illustrates an example of a section near an X-ray output end, the section passing an axis 806 of rotational symmetry and being parallel to the y-z plane in FIG. 7. In FIGS. 7 and 8, the X-ray guiding direction is defined as the z-direction. In FIG. 7, an outer cladding 701 surrounds a core 703, and an inner cladding 702 is disposed in the core 703. Stated another way, the core 703 is sandwiched between the two claddings 701 and 702. FIG. 8 is a schematic sectional view illustrating the section near the X-ray output end, the section passing the axis 806 of rotational symmetry of the X-ray waveguide and being parallel to the y-z plane in FIG. 7, the view including the axis of rotational symmetry 806. Looking at that section, the outer cladding 701 and the core 703 are each drawn as two portions vertically separated, i.e., outer claddings 701(a) and 701(b) and cores 703(a) and 703(b), respectively. Because the structure illustrated in FIG. 8 has mirror symmetry with respect to the axis 806 of rotational symmetry in the y-z plane, the periodic resonant waveguide mode formed inside the waveguide also has mirror symmetry with respect to the axis of rotational symmetry. In other words, the periodic resonant waveguide modes having the same characteristics are formed in the two upper and lower cores 703(a) and 703(b). The X-rays outputting from end surfaces of the cores 703(a) and 703(b) of the X-ray waveguide become two diffracted beams 801 and 802 and two diffracted beams 803 and 804, respectively, in a far field region away from the cores 703(a) and 703(b) for the same reason described above in connection with the example illustrated in FIG. 3. The diffracted beams 802 and 803 intersect in a space. Thus, the output X-rays 802 and 803 are diffracted to converge at one point. Because the X-ray waveguide has circular symmetry, a part of the X-rays emerging from the X-ray waveguide forms a diffracted beam that propagates in a conical shape toward one point in a circular field region, taking into consideration the sections parallel to all the guiding directions. Stated another way, the X-rays can be converged by the X-ray waveguide having the above-described structure. While FIGS. 7 and 8 illustrate the example in which the inside of the core is fully filled with the cladding, the periodic resonant waveguide mode in the X-ray waveguide according to the embodiment of the present invention can also be formed even when the inside of the inner cladding is filled with another substance, e.g., air.

In another typical structure of the X-ray waveguide satisfying the formula (4), as illustrated in FIG. 2B, the core is constructed such that an inner region is fully filled with the periodic structure of the core until reaching the center of rotation without including the inner cladding. In that case, because the X-ray waveguide has the simplest structure, illustrated in FIG. 3, in the section passing the axis of rotational symmetry and being parallel to the guiding direction, the periodic resonant waveguide mode can be formed in that section over the entire core. Furthermore, because the X-ray waveguide has rotational symmetry in the cross-section of the waveguide, the two-dimensional periodic resonant waveguide mode can be formed in phase.

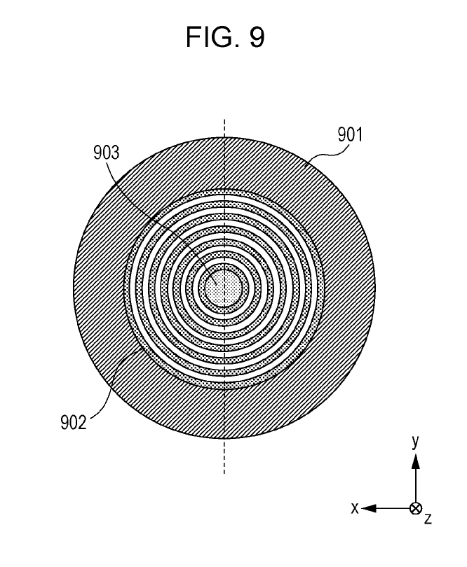

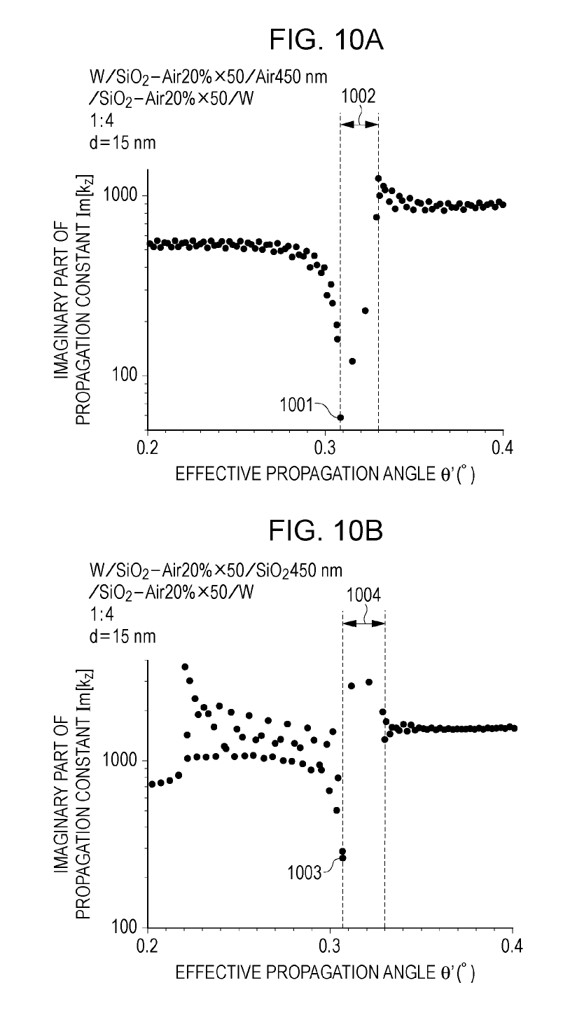

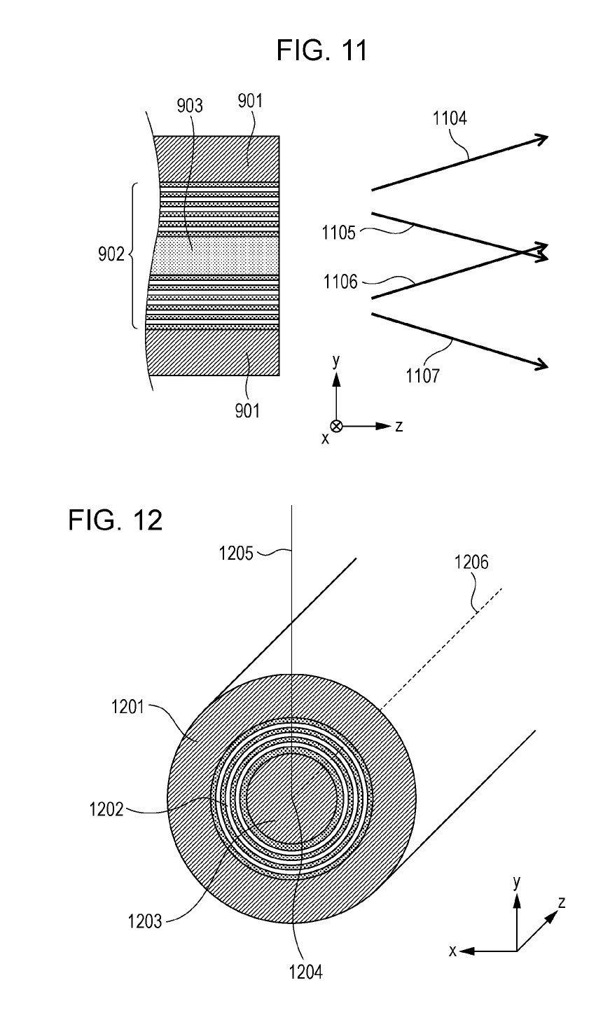

The X-ray waveguide according to the embodiment of the present invention further involves the case where, in the X-ray waveguide of the structure satisfying the formula (4) and not including the inner cladding, a part of the core is not formed of the periodic structure of the core as described above with reference to FIG. 2C. As illustrated in FIG. 9, for example, the X-ray waveguide may be constructed in such a structure that, in the cross-section of the waveguide, a portion 903 differing from the periodic structure of the core is present in a central portion of a core 902 surrounded by a cladding 901. In that case, materials and structural parameters of the X-ray waveguide are determined such that a critical angle for the total reflection at the interface between the portion 903 and the periodic structure of the core in the section perpendicular to the guiding direction is smaller than the Bragg angle of the X-ray for the periodic structure of the core. FIGS. 10A and 10B represent a propagation loss of each waveguide mode in a section, which passes a rotation center and is parallel to a y-z plane in FIG. 9, with respect to an effective propagation angle of the waveguide mode. FIGS. 10A and 10B plot calculation results representing the relationship between the propagation loss and the effective propagation angle of each waveguide mode, respectively, when the refractive-index real part of the portion 903 is larger than the average refractive-index real part of the periodic structure of the core and when the former is smaller than the latter. In more detail, the periodic structure of the core is formed by alternately laminating an air layer and a silica (SiO₂) layer having a density of about 1.7 g/cm³ on the axis of rotational symmetry with a period of 15 nm and a periodic number of 50. The calculation results of FIG. 10A represent the case where the portion 903 is filled with air, and the calculation results of FIG. 10B represent the case where the portion 903 is made of silica (SiO₂) having a density of about 2.2 g/cm³. In both the cases, there are respectively angle bands 1002 and 1004 each corresponding to a photonic band gap. However, because the portion 903 has the structure differing from the periodic structure of the core, the angle ranges 1002 and 1004 include not only periodic resonant waveguide modes 1001 and 1003, respectively, but also waveguide modes in each of which electromagnetic fields are concentrated in the portion 903 due to Bragg reflection with the periodic structure. The latter waveguide modes are concentrated in the portion 903 of the periodic structure of the core, and they appear as defect bands in the photonic band gap of a photonic band structure. Therefore, those waveguide modes are called “defect modes”. When the refractive-index real part of the portion 903 is larger than the average refractive-index real part of the periodic structure of the core, propagation losses of the defective modes are relatively small as illustrated in FIG. 10A, and the defective modes also contribute to propagation of the X-ray to some extent in addition to the periodic resonant waveguide mode. This may enable the X-ray to propagate while resonating with the periodic structure and having a high photon flux density. However, when the refractive-index real part of the portion 903 is larger than the average refractive-index real part of the periodic structure of the core, the number of the defective modes can be reduced or made to be zero by controlling the size of the portion 903 without disturbing the periodicity of the periodic structure of the core. It is hence possible to form the single waveguide mode, in which the field is in phase. In an X-ray band, generally, the refractive-index imaginary part relating to an absorption loss of X-ray reduces as the refractive-index real part of a substance increases. Therefore, when the refractive-index real part of the portion 903 is smaller than the average refractive-index real part of the periodic structure of the core, the absorption loss with the material of the portion 903 is increased and the propagation losses of the defective modes are also increased in comparison with the propagation loss of the periodic resonant waveguide mode 1003, as illustrated in FIG. 10B, to such an extent that the defective modes hardly contribute as the waveguide modes. As a result, only the periodic resonant waveguide mode is very strongly selected as the waveguide mode, and a substantially single waveguide mode can be realized which is spatially coherent over the cross-section of the waveguide. FIG. 11 is a schematic sectional view, taken along a plane including the axis of rotational symmetry and being parallel to the y-z plane, of a portion near an X-ray output end of the X-ray waveguide illustrated in FIG. 9. When the refractive-index real part of the portion 903 is smaller than the average refractive-index real part of the periodic structure of the core, only the periodic resonant waveguide mode becomes a dominant waveguide mode for the propagation of the X-ray, and the total electric field thereof is concentrated in the periodic structure of the core. In FIG. 11, the electric field is concentrated in each of two periodic structure portions of the core sandwiching the portion 903, and X-rays propagating in respective periodic resonant waveguide modes are each diffracted in oppositely-away directions relative to the guiding direction by interference as denoted by a pair of arrows 1104 and 1105 and a pair of arrows 1106 and 1107, respectively, after outputting from the X-ray waveguide. Looking in the direction parallel to the y-z plane as illustrated in FIG. 11, the arrows 1105 and 1106 intersect, and the X-ray intensity at the intersection is increased. Considering that behavior in all the axes of rotational symmetry, X-rays are concentrated at the above-described intersection from all the periodic structure portions of the core in the output end surface, and an X-ray spot having large intensity can be formed with the concentration of the X-rays.

The periodic structure used in the core of the X-ray waveguide according to the embodiment of the present invention may be of any desired type insofar as the periodic structure of the core satisfies the above-described structural conditions of the X-ray waveguide when it has one-dimensional periodicity on the axis of rotational symmetry.

That periodic structure of the core can be formed as a periodic multilayer film. In one example of the periodic multilayer film, a substance exhibiting a relatively large value of the refractive-index real part and a substance exhibiting a relatively small value of the refractive-index real part are alternately laminated in the direction of the axis of rotational symmetry by sputtering. The laminated substances are advantageously at least two selected from among Be, B, C, B₄C, BN, SiC, Si₃N₄, SiN, Al₂O₃, MgO, TiO₂, SiO₂, P, etc.

The core of the X-ray waveguide according to the embodiment of the present invention can also be made of a mesostructured material. The term “mesostructured material” in the present disclosure implies a periodic structure that is made of an organic-inorganic hybrid material, that is formed by self-assembly of a surfactant, and that has a structure period of 2 to 50 nm. There are mesostructures having structure periodicity in various meso-scales. Typical examples of inorganic components of the mesostructures are oxides, such as SiO₂, TiO₂, SnO₂, and ZrO₂.

The core of the X-ray waveguide according to the embodiment of the present invention can be constituted using, among those mesostructures, a mesostructure (lamellar film) having a lamellar structure. Of the mesostructures, a lamellar film having a one-dimensional periodic structure provides the lamellar structure that is a layered structure made of two different types of substances. Those two types of substances include a substance primarily containing an inorganic component and a substance primarily containing an organic component. The substance primarily containing an inorganic component and the substance primarily containing an organic component may be bonded to each other as required. One practical example of the bonded mesostructure is a mesostructure prepared from a siloxane compound to which an alkyl group is bonded. Such a lamellar film can be formed on a substrate by the sol-gel method, for example. The structure period of the lamellar film can be adjusted to a desired value, as appropriate, depending on the type and the concentration of the surfactant used, reaction conditions, etc. Because the lamellar film is formed in the one-dimensional periodic structure by self-organization in one step, time and labor necessary in a fabrication step can be greatly cut. When the lamellar film is used as the one-dimensional periodic structure that constitutes the core of the X-ray waveguide according to the embodiment of the present invention, the propagation loss of the X-ray caused by absorption relating to the propagation loss of the X-ray in the formed periodic resonant waveguide mode can be reduced because one type of the substances constituting the lamellar film is an organic substance absorbing the X-ray in a less amount.

Moreover, the X-ray waveguide according to the embodiment of the present invention can be constituted using a mesoporous material, as the mesostructured material, for the core of the X-ray waveguide. In the mesostructure made of the mesoporous material, pores or voids are periodically arrayed in a homogeneous medium. Therefore, that mesostructure functions as a refractive-index periodic structure in which portions having different refractive indices for the X-ray are periodically arrayed. The mesostructure made of the mesoporous material and constituting the core of the X-ray waveguide according to the embodiment of the present invention has two-dimensional periodicity in the cross-section of the waveguide. Typical examples of that mesostructure include a two-dimensional periodic structure in which pores extending in the guiding direction have a triangular lattice structure in the cross-section of the waveguide, and a three-dimensional periodic structure in which voids are arrayed in a hexagonal close-packed structure. Regardless of whether the mesostructure made of the mesoporous material is the two-dimensional or three-dimensional periodic structure, the structure has two-dimensional periodicity in the cross-section of the waveguide. The interiors of pores or voids in the mesoporous material may be filled with a liquid or a solid regardless of whether the liquid or the solid is an organic substance or an inorganic substance, without being limited to the pores or the voids which are filled with gas, e.g., air, or vacuum. In this specification, air and vacuum are also involved in the concept of “substance” as described above. Accordingly, even when the pores in the mesoporous material are filled with air or vacuum, the mesoporous material can be said as constituting the mesostructure made of plural types of substances because it includes portions having different refractive indices.

When the X-ray waveguide according to the embodiment of the present invention is constructed with satisfaction of the formula (4), a substance forming the cladding is advantageously selected from substances having higher electron densities, such as Au, W, Ta, Pt, Ir and Os, in order to strongly cause the total reflection and to confine the X-ray in the core.

An X-ray waveguide system according to an embodiment of the present invention will be described below. The X-ray waveguide system according to the embodiment of the present invention includes at least an X-ray source and an X-ray waveguide. The X-ray source emits, as an X-ray, an electromagnetic wave in the general X-ray band with wavelength of 10 pm or longer to 100 nm or shorter. The X-ray emitted from the X-ray source may be an X-ray having a single wavelength or a certain width of wavelength. The X-ray emitted from the X-ray source enters an X-ray waveguide. The X-ray waveguide in the X-ray waveguide system according to the embodiment of the present invention includes a core and a cladding. The core has not only threefold or more rotational symmetry in a section perpendicular to the guiding direction of the X-ray, but also a periodic structure made of plural substances differing in value of the refractive-index real part. Moreover, in the X-ray waveguide in the X-ray waveguide system according to the embodiment of the present invention, a critical angle for the total reflection at the interface between the core and the cladding for the X-ray is larger than a Bragg angle of the X-ray for the periodic structure of the core.

The matters described above regarding the X-ray waveguide are similarly applied to the X-ray waveguide in the X-ray waveguide system according to the embodiment of the present invention.

### Example 1

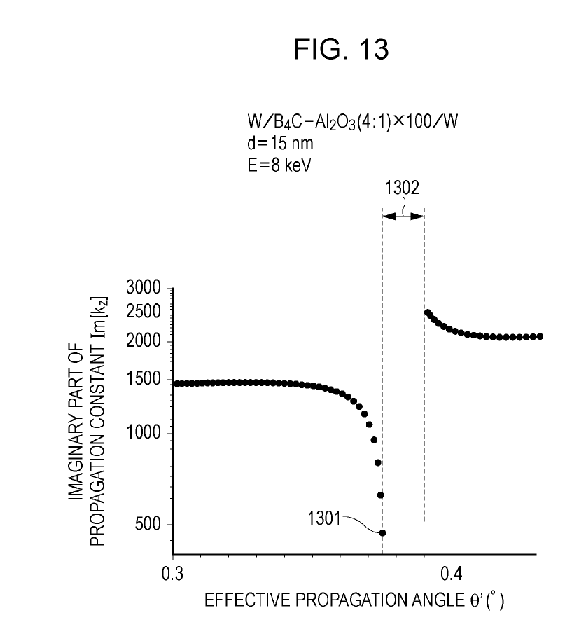

FIG. 12 illustrates an X-ray waveguide according to EXAMPLE 1 of the present invention. Specifically, FIG. 12 illustrates a cross-section of the waveguide taken along an x-y plane with a guiding direction in the waveguide being the z-direction that is parallel to an axis 1206 of rotational symmetry. Numeral 1205 denotes an arbitrary axis of rotational symmetry rotated from a rotation center 1204. The X-ray waveguide has a circularly symmetric structure in the cross-section of the waveguide. In the cross-section of the waveguide, an inner cladding 1203 is formed by a thin wire made of gold (Au) and having a diameter of 100 μm, and a core 1202 has a periodic structure that is formed by concentrically alternately laminating, around the inner cladding 1203, boron carbide (B₄C) and aluminum oxide (Al₂O₃) in a direction gradually departing away from the rotation center with sputtering. Furthermore, an outer cladding 1201 is formed around the core 1202 by coating a film made of tungsten (W) and having a thickness of 20 nm as the outer cladding with sputtering. On the arbitrary axis 1205 of rotational symmetry, the periodic structure of the core 1202 has a structure period of 15 nm and a periodic number of 50. For an X-ray having photon energy of 8 keV, a critical angle for the total reflection at the core-cladding interface between the outer cladding 1201 and the core 1202 is about 0.55°, a critical angle for the total reflection at the core-cladding interface between the inner cladding 1203 and the core 1202 is about 0.56°, and a Bragg angle of the X-ray for the periodic structure is about 0.38°. Accordingly, the critical angle for the total reflections at the two core-cladding interfaces and the Bragg angle satisfy the formula (4). In EXAMPLE 1, there is no waveguide mode having an effective propagation angle corresponding to a Bragg reflection angle band and, of propagation losses of formed waveguide modes, the propagation loss of the periodic resonant waveguide mode is significantly small. Therefore, the periodic resonant waveguide mode becomes a dominant waveguide mode. FIG. 13 is a graph representing a propagation loss and an effective propagation angle of each waveguide mode in a section including the axis 1205 of rotational symmetry and being perpendicular to the guiding direction. As seen from FIG. 13, the propagation loss of a waveguide mode 1301 having the effective propagation angle at the edge of a Bragg reflection angle range 1302 on the lower angle side is significantly small. Such a waveguide mode 1301 is the periodic resonant waveguide mode. Since the same periodic resonant waveguide mode is formed over an entire region in the core, the electromagnetic field of the periodic resonant waveguide mode in the X-ray waveguide of EXAMPLE 1 is in phase over the cross-section of the waveguide. The X-ray outputting from an output end surface of the X-ray waveguide of EXAMPLE 1 is diffracted in two directions that are mirror-symmetric with respect to the guiding direction in a section parallel to all the guiding directions, whereby the diffracted X-rays are converged.

### Example 2

In an X-ray waveguide of EXAMPLE 2, the core 1202 of the X-ray waveguide of EXAMPLE 1, illustrated in FIG. 12, is replaced with mesoporous silica. While the core 1202 of the X-ray waveguide of EXAMPLE 1 is formed by sputtering, the core in EXAMPLE 2 is formed by the sol-gel method. A solution containing a surfactant and a silica source is prepared as a precursor solution for the mesoporous silica. After dipping a thin wire of gold (Au) into the precursor solution, the thin wire is lifted out from the precursor solution. As a result, a mesoporous silica film is formed around the thin wire made of gold (Au) through a self-organization process. The precursor solution for the mesoporous silica is obtained by setting a mixing ratio (molar ratio) to tetraethoxysilane: 1, block polymer: 0.0096, water: 8, hydrochloric acid: 0.01, and ethanol: 40 in a method for preparing the precursor solution. The mesoporous film is formed through the steps of applying the precursor solution around the gold thin wire, drying and aging the applied precursor solution, dipping the gold thin wire into a solvent, and extractively removing the block polymer that has served as a mold. Furthermore, the core of the X-ray waveguide according to the embodiment of the present invention is made of the mesoporous silica obtained after removing organic substances in the pores at the same time as removing the molds. With the presence of those vacant pores, an average refractive index is concentrically periodically changed in the cross-section of the waveguide. On the axis of rotational symmetry, the mesoporous silica has a periodic number of 50 and a structure period of about 11 nm. The core 1202 formed of the mesoporous silica film, which constitutes the periodic structure of the core, surrounds the inner cladding 1203 formed by a thin wire made of gold (Au), and the outer cladding 1201 made of tungsten and surrounding the core 1202 is formed by coating a tungsten film in a thickness of 20 nm with sputtering. For an X-ray having photon energy of 8 keV, a critical angle for the total reflection at the core-cladding interface between the outer cladding 1201 and the core 1202 in the X-ray waveguide of EXAMPLE 2 is about 0.55°, a critical angle for the total reflection at the core-cladding interface between the inner cladding 1203 and the core 1202 is about 0.56°, and a Bragg angle attributable to the periodic structure is about 0.42°. Accordingly, the formula (4) is satisfied. As a result, the periodic resonant waveguide mode confined in the core 1202 can be formed in the section perpendicular to each arbitrary guiding direction. While basic characteristics of the periodic resonant waveguide mode in the X-ray waveguide of EXAMPLE 2 are similar to those of the periodic resonant waveguide mode in the X-ray waveguide of EXAMPLE 1, the propagation loss is reduced because the mesoporous silica material of the core is made of a substance having a smaller absorption loss.

### Example 3

In an X-ray waveguide according to EXAMPLE 3 of the present invention, the periodic structure of the core in the X-ray waveguide of EXAMPLE 2 is replaced with a mesostructure having a lamellar structure in which layers of an organic substance and silica are concentrically alternately laminated when viewed in a cross-section of the waveguide. The mesostructure constituting the core is formed by dipping a thin wire made of Au, which becomes the inner cladding of the core, into a precursor solution prepared for the formation of the mesostructure, and then lifting the thin wire out from the precursor solution. The precursor solution is prepared by adding a precursor of an inorganic oxide into a solution of a surfactant that functions as a mold in an aggregated form. Here, the precursor solution is prepared by employing a block polymer as the surfactant, tetraethoxysilane as the precursor of the inorganic oxide, and ethanol as a solvent, by adding water and hydrochloric acid for hydrolysis of the precursor of the inorganic oxide, and by stirring the mixture. A mixing ratio (molar ratio) is set to tetraethoxysilane: 1, block polymer: 0.0264, water: 8, hydrochloric acid: 0.01, and ethanol: 40. A tri-block copolymer of polyethylene glycol (20)-polypropylene glycol (70)-polyethylene glycol (20) is used as the block polymer (numeral in the parenthesis denotes the repetition number of each block). The mesostructure is formed through the self-organization process that occurs in an evaporation step of the solvent of the introduced solution. The periodic structure of EXAMPLE 3 also has a structure period of about 11 nm on the axis of rotational symmetry and satisfies the formula (4).

### Example 4

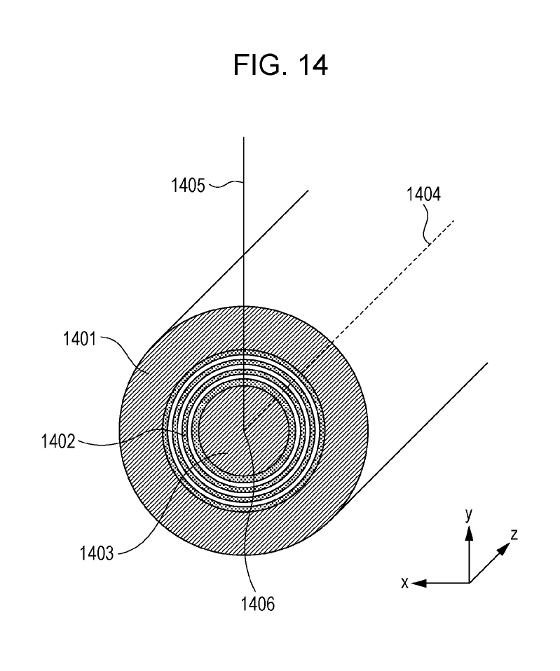

FIG. 14 illustrates an X-ray waveguide according to EXAMPLE 4 of the present invention. Specifically, FIG. 14 illustrates a cross-section of the waveguide parallel to an x-y plane. Numeral 1406 denotes a rotation center of rotational symmetry of the X-ray waveguide, and 1404 and 1405 denote axes of rotational symmetry. The axis 1404 of rotational symmetry is parallel to the guiding direction, and the guiding direction is matched with the z-direction. A mesostructure is formed around a glass fiber 1403 having a diameter of about 10 μm by the sol-gel method. The entirety of the glass fiber 1403 and a core-forming periodic structure 1402 functions as a core. An outer glad 1401 is formed outside the periodic structure 1402 of the core. The mesostructure constituting the periodic structure 1402 of the core has a concentric lamellar structure in which layers of an organic substance and silica (SiO₂) are alternately laminated, thus providing a one-dimensional periodic structure on the axis of rotational symmetry. For example, the one-dimensional periodic structure is provided on an arbitrary axis 1405 of rotational symmetry. On the axis 1405 of rotational symmetry, the periodic structure 1402 of the core has a period of about 11 nm and a periodic number of 60. When an X-ray having photon energy of 8 keV is used, a critical angle for the total reflection at the core-cladding interface between the core and the outer cladding 1401 is about 0.55° in a section including the arbitrary axis 1405 of rotational symmetry and being parallel to the guiding direction, and a Bragg angle attributable to the periodic structure of the core is about 0.4°. Accordingly, the formula (4) is satisfied, and the periodic resonant waveguide mode is formed in which an electric field is concentrated in the periodic structure of the core. Because the glass fiber (silica portion) 1403 has a general density of about 2.2 (g/cm³), it has larger weight than any of the silica and the organic substance both constituting the periodic structure 1402 of the core and exhibits a larger value of the refractive-index imaginary part. In other words, an absorption loss of the X-ray in the silica portion 1403 is larger than that in the periodic structure 1402 of the core, thus resulting in larger propagation losses of waveguide modes in which an electric field is concentrated in the silica portion 1403 with the Bragg reflection in the periodic structure 1402 of the core. This implies that those waveguide modes are not dominant modes. Accordingly, only the periodic resonant waveguide mode becomes a dominant mode, whereby a substantially single waveguide mode can be formed. Since the periodic resonant waveguide mode is spatially coherent over the cross-section of the waveguide and diffracted beams are generated such that X-rays outputting from an output end of the X-ray waveguide intersect in the section parallel to all the guiding directions including the arbitrary axis of rotational symmetry. Accordingly, the X-rays can be converged with the waveguide of EXAMPLE 4.

As described above, each of the embodiments of the present invention can provide the X-ray waveguide capable of producing the waveguide mode that has a phase controlled in two-dimensional directions over a wide cross-section of the core, and that exhibits a small propagation loss. Moreover, the X-ray waveguides according to the embodiments of the present invention can be each used in an X-ray optical system for, e.g., X-ray analysis technology, X-ray imaging technology, and X-ray exposure technology, and in X-ray optical components employed in the X-ray optical system.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-265068, filed Dec. 2, 2011, which is hereby incorporated by reference herein in its entirety.

What is claimed is:

1. An X-ray waveguide comprising:
a core configured to guide X-ray therethrough; and a cladding in contact with the core,
wherein, in a section perpendicular to an X-ray guiding direction, the core has threefold or more rotational symmetry and has a periodic structure made of plural substances each substance having a different value of a real part of refractive-index, and
wherein a critical angle for total reflection of an X-ray at an interface between the core and the cladding is larger than a Bragg angle of the X-ray for the periodic structure of the core.

2. The X-ray waveguide according to claim 1, wherein a critical angle for total reflection of the X-ray at an interface between the different substances of the core is smaller than the Bragg angle of the X-ray for the periodic structure of the core.

3. The X-ray waveguide according to claim 1, wherein the core has circular symmetry.

4. The X-ray waveguide according to claim 1, wherein, in the section perpendicular to the X-ray guiding direction, the cladding is formed inside and outside the core.

5. The X-ray waveguide according to claim 1, wherein, in the section perpendicular to the X-ray guiding direction, a central portion of the core is made of a homogeneous substance that is different from the substances constituting the periodic structure of the core.

6. The X-ray waveguide according to claim 1, wherein the core is made of a periodic multilayer film.

7. The X-ray waveguide according to claim 1, wherein the core is made of mesostructured materials.

8. The X-ray waveguide according to claim 1, wherein the core is made of a mesoporous material.

9. An X-ray waveguide system including an X-ray source and an X-ray waveguide,
the X-ray source emitting X-ray to the X-ray waveguide,
the X-ray waveguide including a core and a cladding,
wherein, in a section perpendicular to an X-ray guiding direction, the core has threefold or more rotational symmetry and has a periodic structure made of plural substances each having a different value of a real part of refractive-index, and
in the section perpendicular to the X-ray guiding direction, a critical angle for total reflection of an X-ray at an interface between the core and the cladding is larger than a Bragg angle of the X-ray for the periodic structure of the core.

10. The X-ray waveguide system according to claim 9, wherein a critical angle for the total reflection of the X-ray at an interface between the different substances of the core is smaller than the Bragg angle of the X-ray for the periodic structure of the core.

11. The X-ray waveguide system according to claim 9, wherein the core has circular symmetry.

12. The X-ray waveguide system according to claim 9, wherein, in the section perpendicular to the X-ray guiding direction, the cladding is formed inside and outside the core.

13. The X-ray waveguide system according to claim 9, wherein, in the section perpendicular to the X-ray guiding direction, a central portion of the core is made of a homogeneous substance that is different from the substances constituting the periodic structure of the core.

14. The X-ray waveguide system according to claim 9, wherein the core is made of a periodic multilayer film.

15. The X-ray waveguide system according to claim 9, wherein the core is made of mesostructured materials.

16. The X-ray waveguide system according to claim 9, wherein the core is made of a mesoporous material.
